(19) United States
(12) Patent Application Publication
(10) Pub. No.: US 2014/0238362 A1
(43) Pub. Date: Aug. 28, 2014

(54) MIXING CHAMBER OF EXHAUST GAS RECIRCULATION SYSTEM

(71) Applicant: Perkins Engines Company Limited, Peterborough (GB)

(72) Inventor: Jean-Yves Tillier, Peterborough (GB)

(73) Assignee: Perkins Engines Company Limited, Peterborough (GB)

(21) Appl. No.: 14/271,603

(22) Filed: May 7, 2014

(51) Int. Cl. F02M 25/07

(52) U.S. Cl. CPC F02M 25/07
USPC 123/568.11

(57) ABSTRACT

A mixing chamber for mixing exhaust gas with intake air, in an engine is provided. The mixing chamber includes a first end, a second end and a side wall. The mixing chamber includes an intake air inlet in fluid communication with the first end of the mixing chamber, an exhaust gas inlet arranged in the side wall of the mixing chamber, located downstream of the intake air inlet and having a leading flow edge corresponding to an intersection of the intake air inlet and the exhaust gas inlet, and a mixing projection located on an inner periphery of the side wall. The mixing projection extends at least partially across the mixing chamber, wherein the mixing projection has a deflection surface and a trailing edge which is at least partially aligned with the leading flow edge of the exhaust gas inlet.

### TECHNICAL FIELD

The present disclosure relates generally to an exhaust gas recirculation system. More specifically, the present disclosure relates to a mixing chamber of an exhaust gas recirculation system.

### BACKGROUND

Combustion in internal combustion engines may result in exhaust gas emissions, including oxides of nitrogen, along with other undesirable pollutants. The internal combustion engines may use an exhaust gas re-circulation (EGR) system to reduce the amount of undesirable pollutants, such as NOx, particulate, soot, etc. generated during a combustion process. The EGR system re-circulates a portion of the exhaust gas back to the plurality of cylinders and mixes with intake air.

The EGR system may include an EGR conduit and a mixer. The EGR conduit may be connected to an exhaust manifold and an intake manifold, thereby providing an EGR flow path from the exhaust manifold to the intake manifold. The EGR gas and the intake air need to be sufficiently well mixed, to provide an even concentration of the EGR gas in the intake air, to enable the reduction of emissions, in particular, nitrous oxides. The mixer is used to properly mix the EGR gas with the intake air. The mixer may simply be a conduit and/or the intake manifold, which may be provided with features, such as vanes, valves, or labyrinths, to increase the mixing characteristics if desired. With these types of mixers, the mixing of the EGR gas with the intake air may not be uniform. In some embodiments, the mixer may be a dedicated fluid mixer assembly. However, the dedicated fluid mixer assembly may increase the overall cost of the EGR system.

### SUMMARY

The present disclosure is related to a mixing chamber of an exhaust gas recirculation system. According to the present disclosure, the mixing chamber includes a first end, a second end and a side wall extending between the first end and the second end. The mixing chamber includes an intake air inlet in fluid communication with the first end of the mixing chamber, an exhaust gas inlet arranged in the side wall of the mixing chamber and located downstream of the intake air inlet, and a mixing projection located on an inner periphery of the side wall. The exhaust gas inlet has a leading flow edge, corresponding to an intersection of the intake air inlet and the exhaust gas inlet, and the intersection being upstream relative to convergence of the exhaust gas flow and the intake air flow. The mixing projection, which is located on the inner periphery of the side wall of the mixing chamber, is being positioned upstream of the exhaust gas inlet. The mixing projection includes a first end proximal to the inner periphery of the sidewall of the mixing chamber and a second end being positioned radially inwards, relative to the inner periphery of the sidewall. The mixing projection includes a trailing edge surface which at least partially extends between the second end of the mixing projection and the leading flow edge of the exhaust gas inlet. The trailing edge surface is aligned with the leading flow edge of the exhaust gas inlet, and structured and arranged to create vortex lift of the intake air flow at the convergence of the exhaust gas flow and intake air flow.

In one aspect of the present disclosure, the mixing chamber comprises one of a delta wing shape, a cuboid shape, a prism shape, a conical shape, a frusto-prism shape, and a frusto-conical shape.

### BRIEF DESCRIPTION OF THE DRAWINGS

FIG. 1 illustrates a schematic of an engine with an EGR system, in accordance with the concepts of the present disclosure;

FIG. 2 illustrates a perspective view of a mixer module of the EGR system of FIG. 1, in accordance with the concepts of the present disclosure;

FIG. 3 illustrates a section view of the mixer module of FIG. 2, in accordance with the concepts of the present disclosure;

FIG. 4 illustrates an end elevation of the mixer module of FIG. 2, in accordance with the concepts of the present disclosure; and

FIG. 5 is a model illustration depicting the principle of vortex lift mixing in a cross flow arrangement, in accordance with the concepts of the present disclosure.

### DETAILED DESCRIPTION

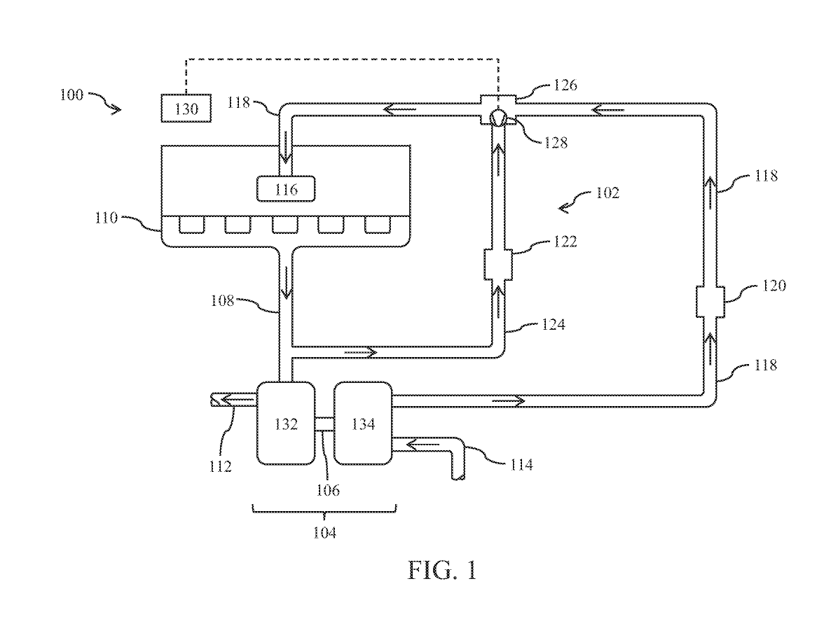

Referring to FIG. 1, there is shown an engine 100 which may include a plurality of cylinders (not shown), an EGR system 102, a turbocharger 104, a common shaft 106, a first exhaust passage 108, an exhaust manifold 110, a second exhaust passage 112, an air intake passage 114, an intake manifold 116, an air supply passage 118, and a charge air cooler 120. The EGR system 102 of the engine 100 may include an EGR gas cooler 122, an EGR gas passage 124, an EGR mixer module 126, an EGR valve 128, and a controller 130.

The turbocharger 104 may include a turbine 132 and a compressor 134, drivably connected to each other, by use of the common shaft 106. The turbocharger 104 may be regarded as being a turbo-charging arrangement comprising multiple turbochargers, such as, in a series configuration. The turbine 132 may be fluidly connected with the exhaust manifold 110, by means of the first exhaust passage 108. Also, the turbine 132 may be fluidly connected to an exhaust system (not shown), via the second exhaust passage 112. The exhaust system (not shown) may include an after treatment system, which removes combustion products from the exhaust gas stream, and one or more mufflers to dampen engine noise, before the exhaust gas is discharged to an ambient environment. The emission from the engine 100 is commonly referred to as exhaust gas, but may in reality be a mixture of gas, other fluids such as liquids, and even solids, comprising for example CO2, H2O, NOx, and particulate matter. The after treatment system may include a diesel particulate filter, a diesel oxidation catalyst and/or a selective catalytic reduction system.

The compressor 134 may receive fresh air or gas or intake air, via the air intake passage 114, which is compressed and supplied to the intake manifold 116 of the engine 100, via the air supply passage 118. The compressed “intake air”, also known as charge air, may be passed through the charge air cooler 120, before it passes into the intake manifold 116.

Further, the EGR system 102 includes the EGR gas passage 124, which fluidly connects the first exhaust passage 108 and the air supply passage 118, so that at least a portion of the exhaust gas may be mixed with the intake air, and recirculated back to the combustion cylinders. This portion of re-circulated exhaust gas may be referred as “EGR gas”. The EGR system 102 may further include the EGR valve 128, which may be controlled by the controller 130, so as to vary the quantity of the exhaust gas flowing through the EGR gas passage 124. The exhaust gas may be passed through the EGR gas cooler 122 to cool the exhaust gas, before it is mixed with the intake air. The order of the EGR gas cooler 122 and the EGR valve 128 may be reversed to give a hot side or a cold side EGR valve 128. The EGR system 102 may be designed as a single unit.

The controller 130 may be a single controller or may comprise a plurality of independent or linked control units. The controller 130 may receive and process signals from various sensor arrangements and may further determine the operating conditions of the engine 100, and/or the EGR system 102.

The EGR system 102 may further include the EGR mixer module 126, which may allow the mixing of the exhaust gas and the intake air to form a mixture. The mixture may be supplied to the intake manifold 116, via the air supply passage 118. The mixture may be then supplied to the plurality of cylinders (not shown), for combustion.

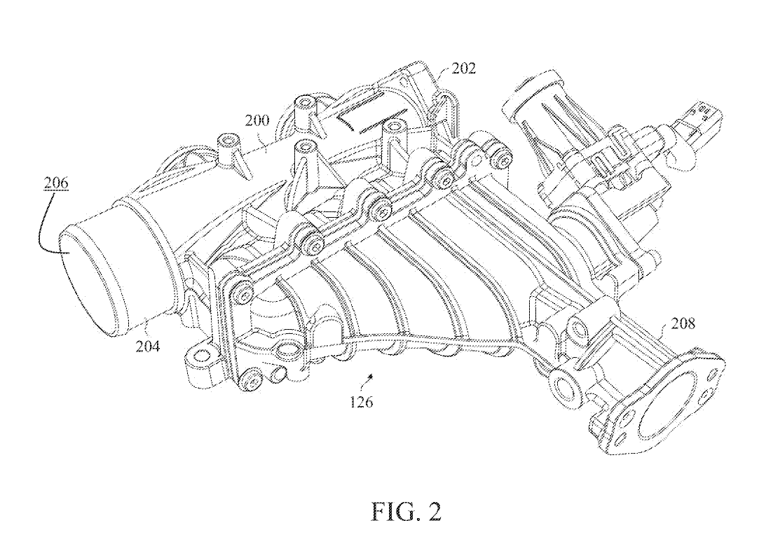

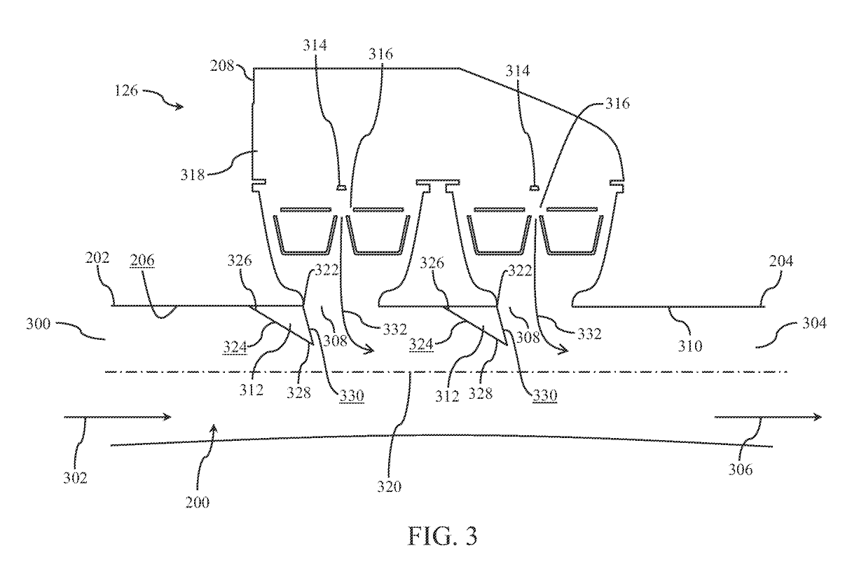

Referring to FIG. 2, there is shown a perspective view of the EGR mixer module 126. The EGR mixer module 126 may include a mixing chamber 200. As best seen in FIG. 3, the mixing chamber 200 may include a first end 202, a second end 204, and a generally cylindrical-shaped sidewall 206. The sidewall 206 extends between the first end 202 and the second end 204 of the mixing chamber 200. Further, the EGR mixer module 126 may include an EGR gas inlet 208 and an intake air inlet 300. The intake air inlet 300 may be positioned at the first end 202 of the EGR mixer module 126 to allow the intake air flow 302 (depicted by an arrow 302) to enter the mixing chamber 200. An outlet 304 may be positioned at the second end 204 of the EGR mixer module 126 to provide the intake air properly mixed with exhaust gas (flow of mixed intake air and exhaust gas depicted by an arrow 306) to the intake manifold 116.

Referring to FIG. 3, further details of the mixing chamber 200 of the EGR mixer module 126 will now be described. The mixing chamber 200 includes a plurality of exhaust gas inlets 308 and at least one mixing projection 312. The exhaust gas inlets 308 are formed in an inner periphery 310 of the sidewall 206. In an exemplary embodiment, the EGR mixer module 126 may include a pair of metering valves 314, such as reed valves, for example, to manage an amount of the exhaust gas, passing through a pair of upstream openings 316 in an exhaust chamber 318 of the EGR mixer module 126. Each of the metering valves 314 is in fluid communication with the exhaust gas inlet 308.

The mixing chamber 200 includes the inner periphery 310 of the sidewall 206, which facilitates and defines therein, the plurality of exhaust gas openings or inlets 308. The exhaust gas, which enters the EGR mixer module 126 through the EGR gas inlet 208, flows into the mixing chamber 200 via the exhaust gas inlets 308. The amount of exhaust gas passing through the exhaust gas inlets 308 and into the mixing chamber 200, is controlled by the metering valves 314, positioned over the upstream openings 316 in the exhaust chamber 318. The mixing chamber 200 may be substantially tubular and may have a longitudinal axis extending along an axial centerline 320 of the mixing chamber 200. Each exhaust gas inlet 308 includes a leading flow edge 322, corresponding to an intersection of the inner periphery 310 of the sidewall 206 and the exhaust gas inlet 308. The intake air and the exhaust gas are mixed in the mixing chamber 200 to form a mixture (illustrated by the arrow 306) and then it passes through the outlet 304, which is disposed on the second end 204 of the mixing chamber 200.

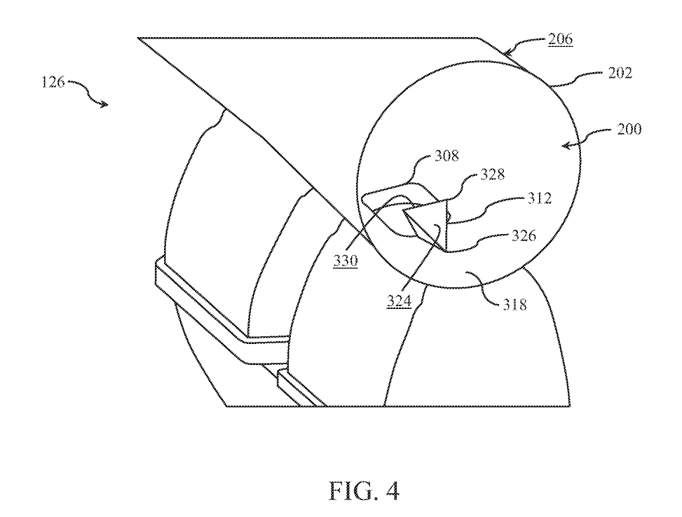

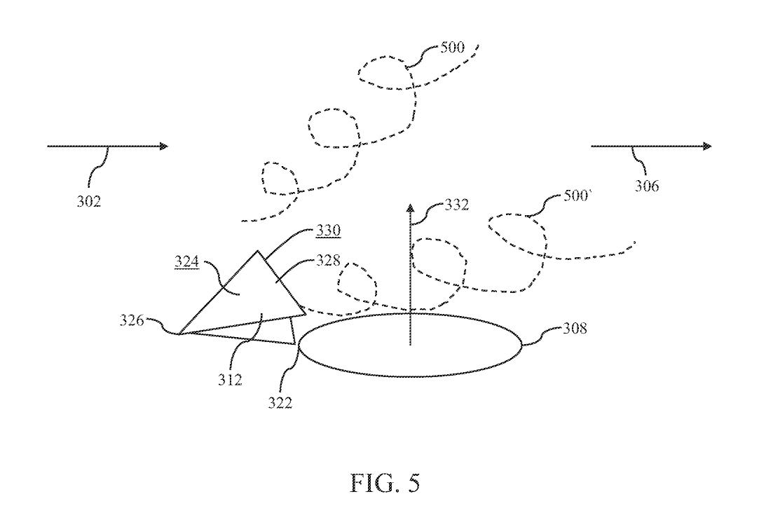

The sidewall 206 includes generally delta winged-shaped mixing projections 312 (FIG. 4). Each of the delta winged-shaped mixing projections 312 has a generally triangular continuous deflection surface 324, which provides an aerodynamic effect termed “vortex lift”, which will be described in further detail below, for the intake air flow 302 directly in front of each exhaust gas inlet 308. Each mixing projection 312 includes a first end 326 which directly overlays or is proximal to the inner periphery 310 of the sidewall 206, and a second end 328 which is downstream of the first end 326 of the mixing projection 312. Each second end 328 of the mixing projection 312 is oriented in a way, such that it is extended into the mixing chamber 200 towards the axial centerline 320 thereof. Each second end 328 of each mixing projection 312 includes a trailing edge surface 330, which is at least partially aligned with the leading flow edge 322 of the exhaust gas inlet 308. Each mixing projection 312 is positioned upstream of its associated exhaust gas inlet 308 and allows the intake air flow 302 to impinge on the deflection surface 324 of the mixing projection 312. Thereafter the intake air flow 302 passes over the trailing edge surface 330 of the mixing projection 312, creating an area of low pressure at the site of the leading flow edge 322 of the exhaust gas inlet 308. This area of low pressure associated with the intake air flow 302 draws the exhaust gas flow 332 (depicted by an arrow 332 in FIG. 3) towards the trailing edge surface 330 of the mixing projection 312 and vortex lift occurs between the intake air and the exhaust gas. The vortex lift results in formation of flow vortices 500 (FIG. 5) which act to enhance the mixing effect. The mixing projection 312 extends at least partially across a width of the mixing chamber 200, coinciding with the width of the exhaust gas inlet 308, for example. In an exemplary embodiment, the mixing projection 312 may have a delta wing shape, a cubical shape, a prism shape, a conical shape, a frusto-prism shape, a wedge shape, or a frusto-conical shape or any other shape known to those having ordinary skill which would generate an area of low pressure along the trailing edge surface 330 of the mixing projection 312. It is envisioned, the mixing projection 312 may be manufactured by die casting, together with the mixing chamber 200, as a single unit or any other suitable constructs known to those having ordinary skill in the art. The dimensions of the mixing projection 312 may be selected in accordance to one or all of the Reynolds number of the intake air flow 302, the Strouhal number, fluid properties, and the desired level of mixing of the EGR system 102 (FIG. 1) and intake gas streams.

Referring to FIG. 4, there is shown end elevation of the EGR mixer module 126, for better understanding and visibility. As illustrated in FIG. 4, the EGR mixer module 126 is shown with the mixing chamber 200, the first end 202 of the mixing chamber 200, the sidewall 206 of the mixing chamber 200, the exhaust gas inlet 308, and the mixing projection 312. The mixing projection 312 includes the trailing edge surface 330, which is at least partially aligned with the leading flow edge 322 of the exhaust gas inlet 308, and the deflection surface 324 which provides the vortex lift for the intake air flow 302 directly in front of each exhaust gas inlet 308.

Referring to FIG. 5, there is shown the principle of vortex lift mixing in the cross flow arrangement. As shown in FIG. 5, the intake air flow 302 impinges on the deflection surface 324 of the mixing projection 312 and passes over the trailing edge surface 330 of the mixing projection 312, creating an area of low pressure at the site of the leading flow edge 322 of the exhaust gas inlet 308. As the intake air flow 302 crosses the mixing projection 312, the vortex lift occurs between the intake air and exhaust gas. This vortex lift results in formation of the flow vortices 500, 500′, which enhances mixing of the intake air flow 302 with the exhaust gas flow 332.

### INDUSTRIAL APPLICABILITY

The disclosed mixing chamber 200 of the EGR system 102 includes the mixing projection 312. The mixing projection 312 provides enhanced mixing of the exhaust gas and the intake air.

During operation of the engine 100, a fuel, such as diesel fuel, may be injected into the plurality of cylinders (not shown) for combustion. As a result of combustion, exhaust gas is produced. The exhaust gas may be directed from the plurality of cylinders (not shown) to the exhaust manifold 110. At least a portion of the exhaust gas within the exhaust manifold 110 may be directed to flow through the first exhaust passage 108. The exhaust gas that flows through the first exhaust passage 108 may be used to drive the turbine 132. Some portion of the exhaust gas supplied to the turbine 132 may be discharged from the turbine 132 to the exhaust system, through the second exhaust passage 112. The exhaust system treats the exhaust gas to reduce the emissions. After treatment of the exhaust gas, through the exhaust system, the favorable exhaust gas is expelled into the environment. Some portion of the exhaust gas may be supplied to the turbine 132. The exhaust gas supplied to the turbine 132 may be directed to the compressor 134. The turbine 132 may transmit power to the compressor 134, via the common shaft 106. The compressor 134 may draw in fresh intake air or other gas and compress it. The compressed intake air may be discharged from the compressor 134. Thereafter, the intake air may pass along the air supply passage 118. The compressed intake air may be cooled by the charge air cooler 120, before flowing into the EGR mixer module 126. The cooled intake air may then flow into the EGR mixer module 126, through the intake air inlet 300.

The portion of the exhaust gas (EGR gas), that remains, is then re-circulated and flows into the EGR mixer module 126. The exhaust gas may flow to the EGR gas cooler 122, via the EGR gas passage 124. The exhaust gas may be cooled by the EGR gas cooler 122, before passing into the EGR mixer module 126, via the EGR gas inlet 208. The flow of the exhaust gas into the EGR mixer module 126 may be controlled by the EGR valve 128. When the EGR valve 128 is in a closed position, no exhaust gas enters the EGR mixer module 126. At this point, the intake air passes through the mixing chamber 200 and out of the outlet 304, to the intake manifold 116 for combustion.

When the EGR valve 128 is in an open position, the exhaust gas may flow into the EGR mixer module 126, via the EGR gas inlet 208. Thereafter, the exhaust gas may enter the mixing chamber 200, via the exhaust gas inlet 308, where mixing of the exhaust gas with the intake air occurs.

The intake air may enter the mixing chamber 200, via the intake air inlet 300. The intake air enters through the intake air inlet 300, such that the intake air flow 302 (depicted by the arrow 302 in FIG. 3) is incident on the deflection surface 324 of the mixing projection 312. The intake air flows past the mixing projection 312, as it enters the mixing chamber 200, via the intake air inlet 300. The mixing projection 312 creates turbulence as the intake air is deflected by the deflection surface 324 and passes over the trailing edge surface 330 of the second end 328 of the mixing projection 312. This creates a vortex sheet, thereby creating an area of low pressure at the site of the leading flow edge 322 of the exhaust gas inlet 308. This enhances the penetration of the stream of exhaust gas into the stream of intake air, by drawing the exhaust gas flow 332 (depicted by the arrow 332 in FIG. 3) towards the trailing edge surface 330 of the mixing projection 312. This results in the vortex lift between the intake air and the exhaust gas resulting in flow vortices 500, 500′ (FIG. 5) which enhances the mixing effect.

Also, the use of the mixing chamber 200 with the mixing projection 312 may be advantageous, in that only a relatively minor and inexpensive change is required in the manufacturing process to produce the mixing chamber 200 with the mixing projection 312. In particular, if the mixing chamber 200 is manufactured by die casting, it is expected that the metal dies used in such a process may be easily modified to produce the mixing projection 312.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A mixing chamber for mixing exhaust gas with intake air in an engine, the mixing chamber having a first end, a second end, and a side wall extending between the first end and the second end, the mixing chamber comprising:
an intake air inlet in fluid communication with the first end of the mixing chamber;
an exhaust gas inlet defined in the side wall of the mixing chamber and located downstream of the intake air inlet, the exhaust gas inlet having a leading flow edge corresponding to an intersection of the intake air inlet and the exhaust gas inlet and the intersection being upstream relative to convergence of the exhaust gas flow and the intake air flow; and
a mixing projection located on an inner periphery of the side wall of the mixing chamber and being positioned upstream of the exhaust gas inlet, said mixing projection having a first end proximal to the inner periphery of the sidewall of the mixing chamber and the mixing projection having a second end being positioned radially inwards, relative to the inner periphery of the sidewall, the mixing projection having a trailing edge surface at least partially extending between the second end of the mixing projection and the leading flow edge of the exhaust gas inlet, wherein the trailing edge surface being aligned with the leading flow edge of the exhaust gas inlet and being structured and arranged to create vortex lift of the intake air flow at the convergence of the exhaust gas flow and intake air flow.

2. A mixing chamber according to claim 1, wherein the mixing projection comprises one of a delta wing shape, a cuboid shape, a prism shape, a conical shape, a frusto-prism shape, and a frusto-conical shape.

3. An internal combustion engine comprising a mixing chamber according to claim 1 or 2.
